(19) United States
(12) Patent Application Publication
(10) Pub. No.: US 2013/0222278 A1
(43) Pub. Date: Aug. 29, 2013

(54) ELECTRONIC DEVICE AND METHOD FOR SETTING EDITING TOOLS OF THE ELECTRONIC DEVICE

(71) Applicants: SHU-PING CHEN, Tu-Cheng (TW); HSIAO-PING CHIU, Tu-Cheng (TW)

(72) Inventors: SHU-PING CHEN, Tu-Cheng (TW); HSIAO-PING CHIU, Tu-Cheng (TW)

(73) Assignee: HON HAI PRECISION INDUSTRY CO., LTD., Tu-Cheng (TW)

(21) Appl. No.: 13/523,904

(22) Filed: Jun. 15, 2012

(30) Foreign Application Priority Data
Feb. 29, 2012 (TW) 101106441

(51) Int. Cl. G06F 3/041

(52) U.S. Cl. 345/173

(57) ABSTRACT

An electronic device acquires first character data of a hand, and displays an outline diagram of the hand on a touch screen display according to the first character data, in response to a user placing his/her hand on the touch screen display. The electronic device sets associations between editing tools and fingers of the hand in the outline diagram. Then, the electronic device detects second character data of a finger of the hand in response to the user touching the touch screen display with the finger, and compares the second character data with the first character data, to determine which editing tool is associated with that finger according to the set associations, and replaces a present available editing tool on the touch screen display with the determined editing tool.

### BACKGROUND

1. Technical Field

Embodiments of the present disclosure generally relate to electronic devices, and particularly to an electronic device and a method for setting editing tools of the electronic device.

2. Description of Related Art

Drawing toolbars, which allow users to draw objects like boxes, lines, circles, ovals and arrows, are found in many applications. There are many drawing and editing tools in a drawing toolbar, but only a few of the tools are commonly used, which causes users to spend much time in finding a desired tool from the drawing toolbar. It is a waste of time and not convenient for the users.

### BRIEF DESCRIPTION OF THE DRAWINGS

FIG. 1 is a schematic diagram of one embodiment of an electronic device.

FIG. 2 is a block diagram of one embodiment of function modules of a control unit of the electronic device in FIG. 1.

FIG. 3 is a flowchart of one embodiment of a method for setting editing tools of the electronic device.

FIG. 4 is a schematic diagram of one embodiment of a touch area of a touch screen display of the electronic device.

FIG. 5 is a schematic diagram of one embodiment of an outline diagram on the touch screen display.

FIG. 6 is a schematic diagram of one embodiment of setting associations between editing tools and fingers as outlined in the outline diagram.

FIG. 7 is a schematic diagram of one embodiment of the set editing tools associated with each finger of the outline diagram.

FIG. 8 is a flowchart of one embodiment of highlighting a finger of the outline diagram on the touch screen display.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

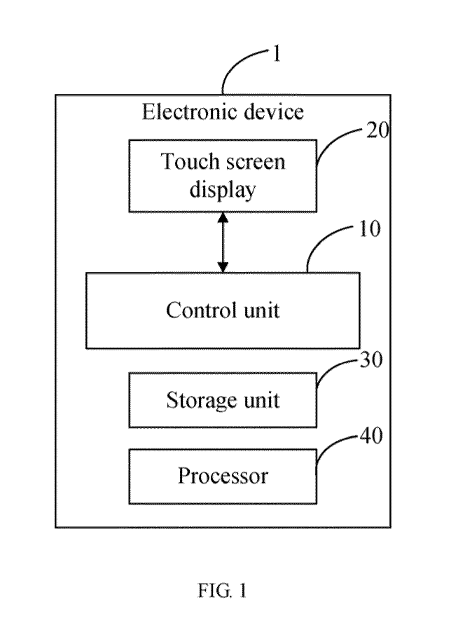

FIG. 1 is a schematic diagram of one embodiment of an electronic device 1. In the embodiment, the electronic device 1 includes a control unit 10, a touch screen display 20, a storage unit 30, and a processor 40. The electronic device 1 may be a touch screen computer or a mobile phone, for example.

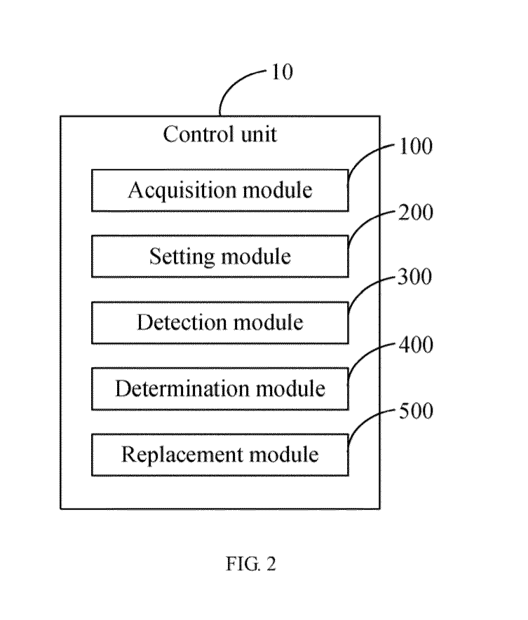

In one embodiment, the control unit 10 may include one or more function modules (a description is given in FIG. 2). The one or more function modules may comprise computerized code in the form of one or more programs that are stored in the storage unit 30, and executed by the processor 40 to provide the functions of the control unit 10. The storage unit 30 may be a cache or a dedicated memory, such as an EPROM or a flash memory.

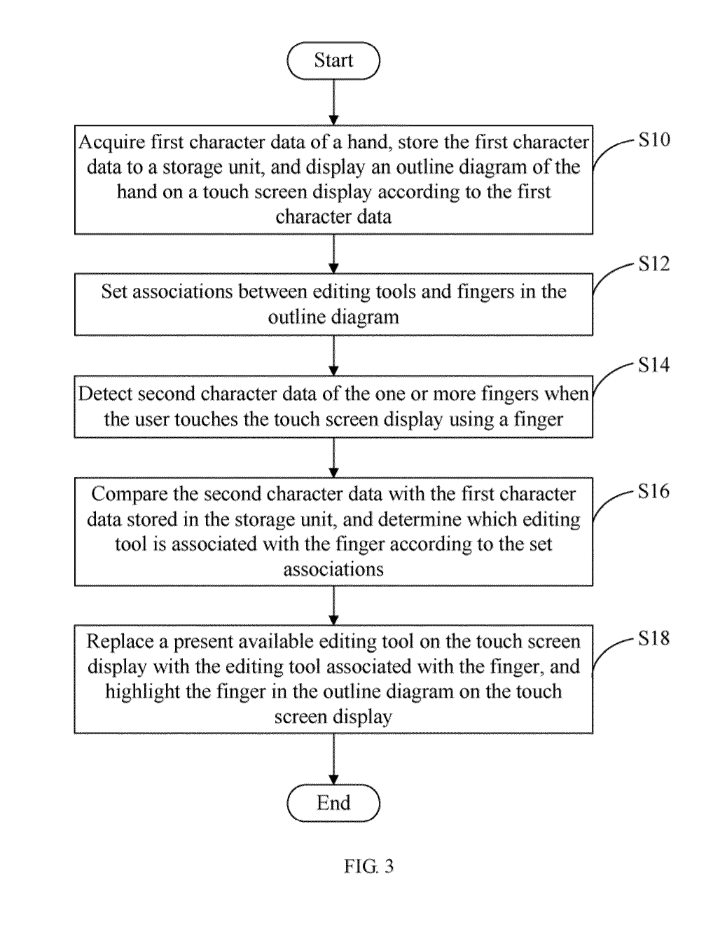

FIG. 2 is a block diagram of one embodiment of the function modules of the control unit 10. In one embodiment, the control unit 10 includes an acquisition module 100, a setting module 200, a detection module 300, a determination module 400, and a replacement module 500. A detailed description of the functions of the modules 100-500 is given in FIG. 3.

FIG. 3 is a flowchart of one embodiment of a method for setting editing tools of the electronic device 1. Depending on the embodiment, additional steps may be added, others removed, and the ordering of the steps may be changed.

In step S10, the user may place his/her hand on a touch area 201 (as shown in

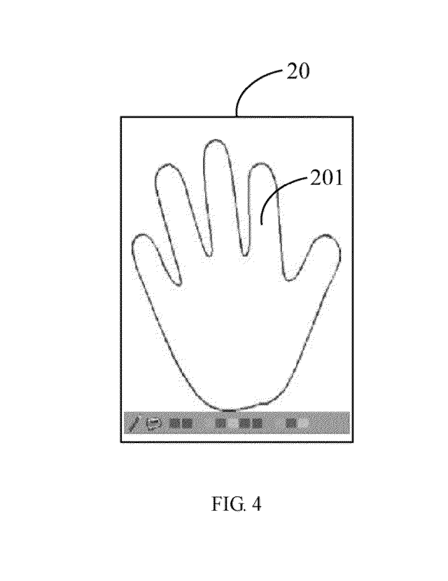

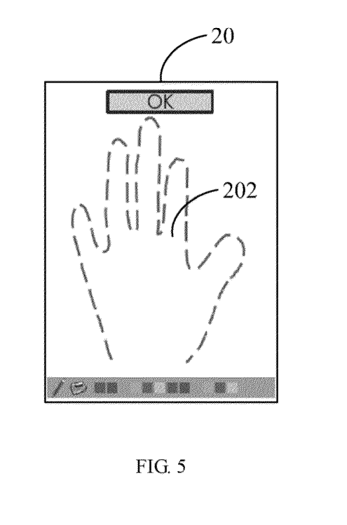

FIG. 4) of the touch screen display 20. The acquisition module 100 acquires first character data of the hand, stores the first character data to the storage unit 30, and displays an outline diagram 202 of the hand (as shown in FIG. 5) on the touch screen display 20 according to the first character data. In the embodiment, the first character data including character data (e.g., a fingerprint or a texture or a size) of each finger of the hand, is acquired by applying image induction and recognition technology. The touch area 201 is a preset area on the touch screen display 20.

The outline diagram comprises various editing tools. In step S12, the setting module 200 sets associations between the editing tools and the fingers in the outline diagram 202. In the embodiment, the user can set associations between favorite editing tools and one or more fingers of the hand by using a finger of the hand or a stylus (e.g., a pen or a mouse) and dragging the favorite editing tool to the finger in the outline diagram 202. The setting module 200 then stores all the associations between the editing tools and the fingers of the outline diagram to the storage unit 30.

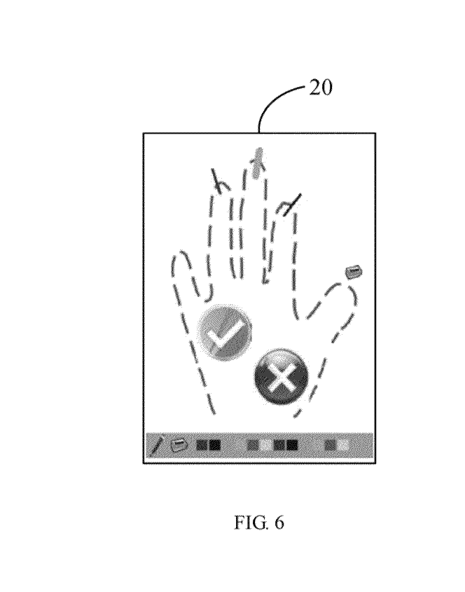

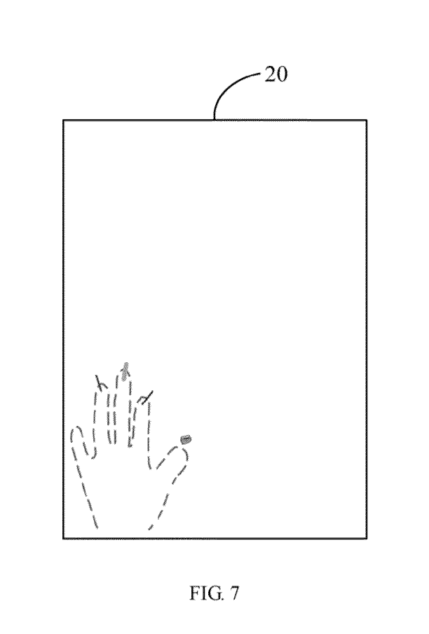

In one embodiment, five editing tools can be associated with the outline diagram 202 (as shown in FIG. 6). For example, in FIG. 6, an eraser is set to be associated with a thumb of the outline diagram 202, a blue pencil is set to be associated with a forefinger of the outline diagram 202, an orange fluorescent night writer pen is set to be associated with a middle finger of the outline diagram 202, and a red pencil is set to be associated with a third finger of the outline diagram 202. After the associations have been set, the outline diagram 202 is displayed at a region (such as lower left corner) of the touch screen display 20 (as shown in FIG. 7).

In step S14, the detection module 300 detects second character data of the one or more fingers when the user touches the touch screen display 20 using a finger (any one of the one or more fingers mentioned above). The second character data including character data (e.g., a fingerprint or a texture or a size) of the finger, is acquired by applying the image induction and recognition technology. For example, if the user touches the touch screen display 20 with the middle finger, the detection module 300 detects the second character data of the middle finger.

In step S16, the determination module 400 compares the second character data with the first character data stored in the storage unit 30, and determines which editing tool is associated with the finger according to the set associations. For example, if the determination module 400 compares the second character data with the first character data stored in the storage unit 30, and determines that the finger is the middle finger, then the determination module 400 determines that the associated editing tool is the orange fluorescent pen.

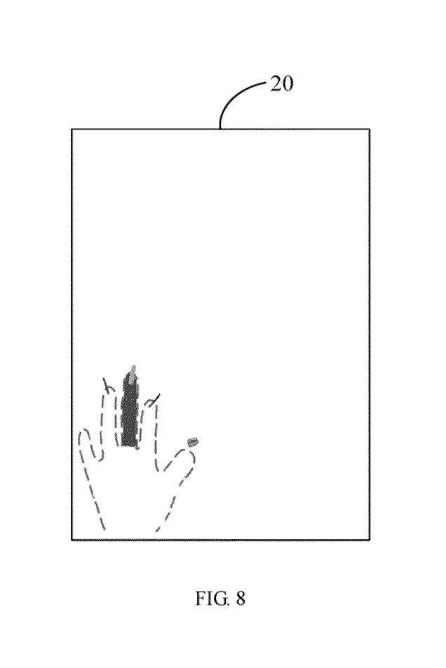

In step S18, the replacement module 500 replaces a present available editing tool (e.g., a current editing tool) on the touch screen display 20 with the editing tool associated with the finger, and highlights the finger in the outline diagram 202 on the touch screen display 20. For example, if the determined editing tool is the orange fluorescent pen, the replacement module 500 replaces the present editing tool (which might be a blue pencil) on the touch screen display 20 with the orange fluorescent pen, and highlights the middle finger of the outline diagram 202 on the touch screen display 20 (as shown in FIG. 8).

In the embodiment, users can write or draw on the touch screen display 20 using an input tool (such as a touch-pencil), and touch the touch screen display 20 with a finger to select a desired editing tool according to preset associations between the editing tools and the fingers.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of an electronic device comprising a touch screen display, the method comprising:
(a) in response to a user placing his/her hand on the touch screen display, acquiring first character data of the hand, and displaying an outline diagram of the hand on the touch screen display according to the first character data;
(b) setting associations between editing tools and fingers of the hand in the outline diagram;
(c) detecting second character data of a finger of the hand in response to the user touching the touch screen display with the finger;
(d) comparing the second character data with the first character data, and determining which editing tool is associated with the finger according to the set associations; and
(e) replacing a present available editing tool on the touch screen display with the editing tool associated with the finger.

2. The method as claimed in claim 1, wherein the step (b) comprises:
setting associations between favorite editing tools and one or more fingers by using a finger of the hand or a stylus and dragging the favorite editing tool to the finger in the outline diagram; and
storing all the associations between the editing tools and the fingers in the outline diagram in a storage unit of the electronic device.

3. The method as claimed in claim 1, wherein the first character data and the second character data are acquired by applying image induction and recognition technology.

4. A non-transitory storage medium storing a set of instructions, the set of instructions capable of being executed by a processor of an electronic device comprising a touch screen display, to perform a method for setting editing tools of the electronic device, the method comprising:
(a) in response to a user placing his/her hand on the touch screen display, acquiring first character data of the hand, and displaying an outline diagram of the hand on the touch screen display according to the first character data;
(b) setting associations between editing tools and fingers of the hand in the outline diagram;
(c) detecting second character data of a finger of the hand in response to the user touching the touch screen display with the finger;
(d) comparing the second character data with the first character data, and determining which editing tool is associated with the finger according to the set associations; and
(e) replacing a present available editing tool on the touch screen display with the editing tool associated with the finger.

5. The non-transitory storage medium as claimed in claim 4, wherein the step (b) comprises:
setting associations between favorite editing tools and one or more fingers by using a finger of the hand or a stylus and dragging the favorite editing tool to the finger in the outline diagram; and
storing all the associations between the editing tools and the fingers in the outline diagram in a storage unit of the electronic device.

6. The non-transitory storage medium as claimed in claim 4, wherein the first character data and the second character data are acquired by applying image induction and recognition technology.

7. An electronic device, the electronic device comprising:
a touch screen display;
a storage unit;
at least one processor;
one or more programs that are stored in the storage unit and are executed by the at least one processor, the one or more programs comprising:
an acquisition module that acquires first character data of a hand, and displays an outline diagram of the hand on the touch screen display according to the first character data, in response to a user placing his/her hand on the touch screen display;
a setting module that sets associations between editing tools and fingers of the hand in the outline diagram;
a detection module that detects second character data of a finger of the hand in response to the user touching the touch screen display with the finger;
a determination module that compares the second character data with the first character data, and determines which editing tool is associated with the finger according to the set associations; and
a replacement module that replaces a present available editing tool on the touch screen display with the editing tool associated with the finger.

8. The electronic pencil as claimed in claim 7, wherein the setting module sets associations between favorite editing tools and one or more fingers by using a finger of the hand or a stylus and dragging the favorite editing tool to the finger in the outline diagram, and stores all the associations between the editing tools and the fingers in the outline diagram in the storage unit.

9. The electronic pencil as claimed in claim 7, wherein the first character data and the second character data are acquired by applying image induction and recognition technology.
